(19) United States
(12) Patent Application Publication
(10) Pub. No.: US 2006/0169092 A1
(43) Pub. Date: Aug. 3, 2006

(54) Adjustable pedal

(76) Inventors: Jaume Prat Terradas, Barcelona (ES); David Gras Alonso, San Cugat del Valles (ES); Daniel Monedero Uribe-Echebarria, San Cugat del Valles (ES)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/535,219

(22) PCT Filed: Nov. 24, 2003
(86) PCT No.: PCT/EP03/13178

§ 371 Date: Dec. 27, 2005

(30) Foreign Application Priority Data
Nov. 22, 2002 (DE) 102 54 585.5

(51) Int. Cl. G05G 1/14

(52) U.S. Cl. 74/512

(57) ABSTRACT

This invention relates to an adjustable position pedal (20), in particular for the use in a motor vehicle, which comprises a subpedal (1), which is pivotably mounted at the motor vehicle, a pedal (4), which is slideably arranged at the subpedal (1), as well as a positioning element (8), which is pivotably mounted at the subpedal (1) and slideably mounted at the pedal (4), so that the pedal (4) glides relatively to the subpedal (1) during a pivoting of the positioning element (8).

### 1. TECHNICAL FIELD

The present invention relates to an adjustable position pedal, which can be optimally adjusted with regard to the user, without negatively affecting the function of the pedal. The present invention relates in particular to a brake pedal, clutch pedal, or gas pedal of a motor vehicle.

### 2. PRIOR ART

The problem of adjusting the position of a pedal so that it can be actuated by the user optimally is apparent in many fields of mechanics, such as in mechanical engineering or motor vehicle construction. In motor vehicles, there is the problem of adjusting the pedal position to drivers of different size and with legs of different length. Until now, this was substantially made possible by means of adjusting the seat. Most recently, it became possible by means of various technical solutions, to also adjust the position of the pedal to the driver's size.

Additional security elements, such as the airbag in the steering wheel, provide an increased protection of the passengers of the motor vehicle possible in case of an accident, if the driver is located at the correct distance from the steering wheel. If the position of the driver to the pedals is effected by means of adjusting the seat position, the driver's position in relation to the steering wheel is changed. This may impair or abolish the airbag's function. Thus, it is desirable to use adjustable pedals in motor vehicles. Moreover, adjustment of the pedals makes it possible to adjust the driver's seating position to the sight on the dashboard and on the road, and to adjust the pedals along the preferred seating position. This moreover increases security in traffic.

The prior art provides various technical solutions for adjustable pedals. One technical solution for adjustable pedals is represented in documents U.S. Pat. No. 5,819,593 and U.S. Pat. No. 5,460,061. Herein, the suspension of the pedal is displaceably mounted on an axis running in parallel to the motor vehicle's longitudinal axis. On this axis, the suspension of the pedal is electrically displaced towards the driver or away from the driver. Thus, adjusting the pedal position to the seating position of the respective driver is possible. However, the adjustment axis of the pedal protrudes into the driver's area. In the case of a front collision of the vehicle, this results in an increased danger of injury for the driver's legs, since the massive adjustment axis is pushed into the area of the legs by the deforming chassis of the vehicle.

Further technical solutions for adjustable pedals are described in the documents EP 0 918 273 A1, U.S. Pat. No. 5,823,064, or U.S. Pat. No. 5,855,143. In these solutions, a pedal is turned towards the driver so that, in addition to the adjustment of the pedal in parallel to the vehicle's longitudinal axis, an undesired height adjustment of the pedal results. This height adjustment causes that small drivers, mostly also having small feet, have to lift their feet from the vehicle's floor for secure actuation of the pedal. The driver is then no longer able to support his heel on the floor, which is most uncomfortable for him and leads to fatigue and muscle strains.

This problem is taken up by DE 100 33 703 A1, wherein an adjustment mechanism for a pedal is disclosed, wherein the distance between the pedal foot and the vehicle's floor remains substantially constant. This mechanism consists of a pedal and a subpedal, adjustably connected by means of a mechanism of scissors type. This mechanism of scissors has the disadvantage of consisting of comparatively filigree elements, interconnected via various joints. The mechanism of scissors is subjected to a high bending load in particular at the intersections of the scissors. Correspondingly, these elements have to be of sufficiently strong dimensions in order not to fail, in particular in the case of a brake pedal.

Thus, the problem on which the invention is based consists of providing an improved possibility for the adjustment of vehicle pedals, which does not show the above-mentioned problems. Moreover, the technical realization of the adjustable pedal is preferably to provide a simpler construction of low-cost materials. Furthermore, the construction is to be capable of build-in into various motor vehicles, independent of the vehicle type.

### 3. SUMMARY OF THE INVENTION

In accordance with the invention, the problem on which the invention is based is solved by means of an adjustable pedal assembly in accordance with patent claim 1.

The adjustable pedal assembly, in particular for the use in a motor vehicle, comprises a subpedal, which is pivotably mounted at the motor vehicle, a pedal, which is slideably arranged at the subpedal, as well as at least one positioning element, which is pivotably mounted at the subpedal and slideably mounted at the pedal, so that the pedal glides relatively to the subpedal during a pivoting of the positioning element.

Thus, the adjustable pedal assembly has substantially only three elements, namely the pedal, the subpedal, and the positioning element. Such a construction of substantially only three components is very robust and requires low-maintenance, and the bending loads on the individual components are minimized. By the gliding arrangement of the elements to each other, only tear forces and forces of pressure are transferred to the individual elements.

Preferably, the positioning element consists only of a single element, which is mounted at the pedal by two separate links.

Therein, it is to note that the described assembly is a kinematics which preferably moves substantially within one or parallel to one plane. For the pedals of a motor vehicle, this is usually the plane defined by the longitudinal axis and vertical axis of the vehicle. In the following, it is referred to the axes of the vehicle, wherein this reference is then based on the usual build-in position of the pedals in a vehicle; i.e. the pedal substantially pivots around an axis, running in parallel to the transverse axis of the vehicle when actuated by the driver.

The subpedal preferably comprises a first elongated guide and the pedal is slideably supported within this first elongated guide by a link, so that the pedal is substantially adjustable in parallel to the vehicle's longitudinal axis. This results in the pedal maintaining its distance to the vehicle's floor when adjusted. Thus, drivers with shorter legs, having adjusted the pedal closer towards themselves, are also able to comfortably support their foot on the vehicle's floor.

Preferably, the pedal comprises a second and third elongated guide. Preferably, the paths of the first, second and third elongated guides are arranged such that when a force is applied to a foot-piece of the pedal to operate it, a locking in the relative movement of the subpedal, the pedal and the positioning element to each other is produced. Therefore, a possible actuating means which actuates the adjustment of the pedal assembly has to take up low forces or no forces at all during an actuation of the pedal. This improves the lifetime of the actuating means and the reliability of the pedal assembly.

Preferably, the paths of the three elongated guides are arranged, so that the foot-piece of the pedal follows a predetermined trajectory during the adjustment of the pedal. It is therefore possible to determine the path, which the foot-piece of the pedal follows during the adjustment of the pedal assembly. The foot-piece of pedal may follow a curved path, for example in parallel to a curved floor of the vehicle.

In another preferred embodiment, the pedal comprises a first pin, engaging the first elongated guide. Preferably, the positioning element comprises a second pin, engaging the second elongated guide, and also a third pin, engaging the third elongated guide, wherein said three links are provided. The pins substantially take up force components running perpendicular to the path of the corresponding elongated guide. The elongated guides allow a movement of the corresponding pins in the direction being defined by the respective path of the elongated guide.

The paths of the elongated guides preferably are substantially in parallel to a plane defined by the vehicle's longitudinal axis and the vehicle's vertical axis.

It is moreover preferred that the path of the first elongated guide in the subpedal is substantially straight. The paths of the second and third elongated guides are preferably curved. The arrangements of the elongated guides in the individual components as well as the geometric dimensions define the adjustment possibilities of the pedal. Preferably, the path of the first elongated guide is arranged substantially horizontal when the pedal is not actuated.

As already indicated above, the movements of the pedal arrangement take place substantially within that plane which is defined by the vehicle's longitudinal axis and the vehicle's vertical axis. The positioning element is preferably pivotable around an axis, which is substantially in parallel to the vehicle's transverse axis.

The rotation point of the positioning element is preferably located below the rotation point of the subpedal. The path of the first elongated guide is directed preferably between the rotation point of the subpedal and the rotation point of the positioning element.

Preferably, the sub-pedal comprises two external parallel walls, which are mechanically connected, wherein the at least one positioning element and the pedal are mounted in-between the two walls by means of the elongated guides and the corresponding pins.

Preferably, the at least one positioning element comprises a V-shaped plate, which is pivotably mounted at the vertex of the V-shaped plate and wherein the second and third pins are arranged at the arms of the V-shaped plate.

In a preferred embodiment, the positioning element or the pedal are driven by an electric motor or manually. Particularly preferable, the positioning element or the pedal are either driven by means of a toothed wheel gearing, a spindle gearing, a cam gearing, a chain drive, a belt drive, or a V-belt drive, a flexible shaft, or by a combination of said gearings.

In another preferred embodiment, at least two of the pedal assemblies are grouped into a pedal unit, wherein the respective positioning elements or the pedals of the pedal assemblies are jointly driven. This results in a joint adjustment of the pedals of the vehicle. Particularly preferable, only a single, common adjustment element is used for adjustment.

Further preferred embodiments of the invention result from the subclaims.

### 4. BRIEF DESCRIPTION OF THE DRAWINGS

In the following, the preferred embodiments of the present invention are described with reference to the drawings. Therein shows:

FIG. 1 a side view of a preferred embodiment of an adjustable pedal of the invention, wherein the pedal has been adjusted to a small driver;

FIG. 2 the embodiment of the adjustable pedal of FIG. 1 wherein it has been adjusted to a big driver;

FIG. 3 a three-dimensional view of the embodiment of the adjustable pedal;

FIG. 4 an explosionary three-dimensional view of the embodiment of the adjustable pedal, showing the main elements of the adjustable pedal;

FIG. 5 a side view of a further embodiment of the adjustable pedal, showing the subpedal only.

### 5. DETAILED DESCRIPTION OF THE PREFERRED EMBODIMENTS

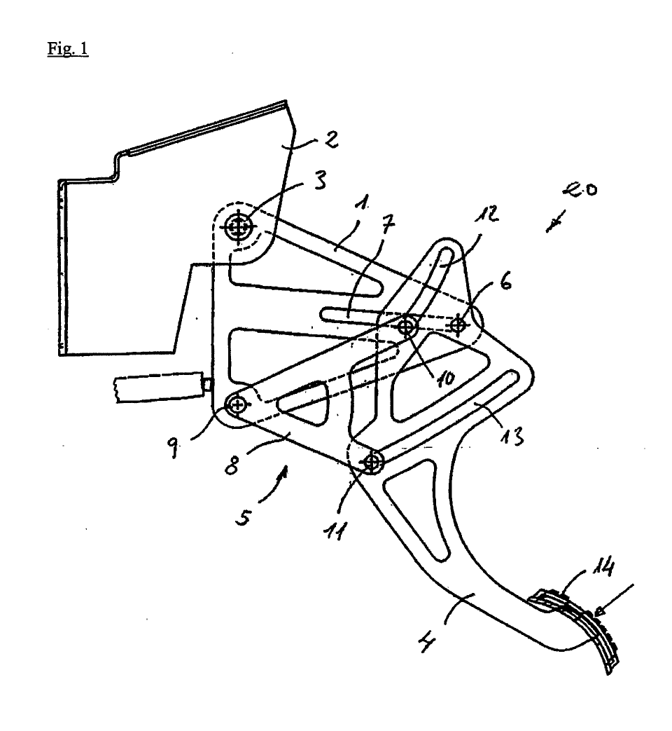

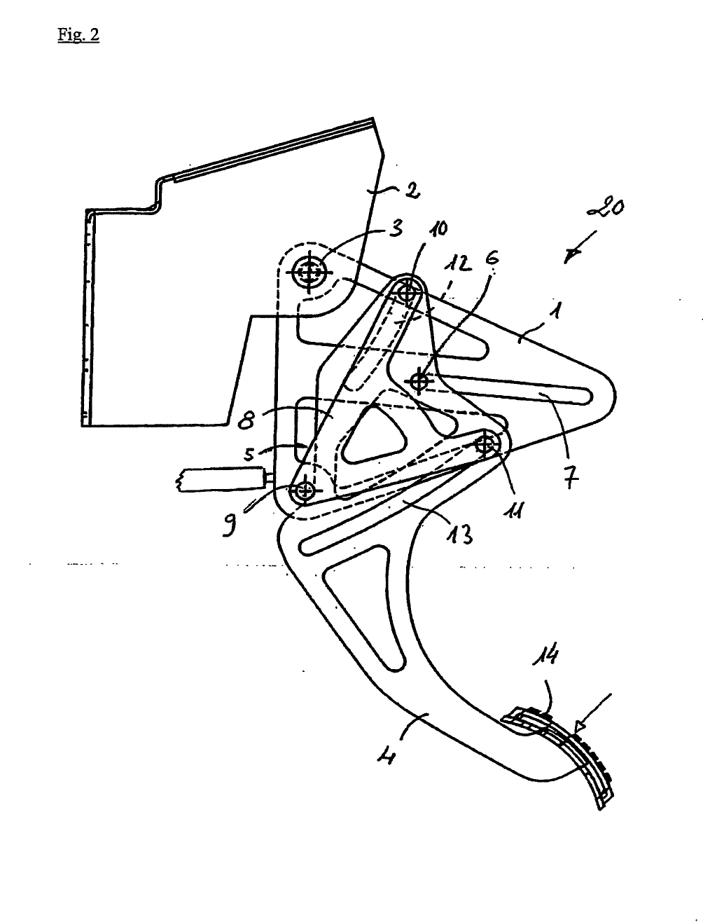

In FIGS. 1 and 2, an embodiment of the present invention is schematically shown. The adjustable pedal assembly 20 consists substantially of three elements, namely the subpedal 1, the positioning element 8 and the pedal 4.

The subpedal 1 is pivotably mounted on a fixed support 2 on the vehicle chassis. The rotation point of the subpedal 3 corresponds to the rotation point of a common pedal. The subpedal 1 is connected with the device to be actuated by the pedal. This may be a sheathed cable or a connecting rod for actuating the clutch, or, in the case of the brake pedal, the main brake cylinder. It is of course also possible to connect the gas cable to the subpedal 1. It is also possible for all common mechanical, hydraulic, pneumatic or electronical transfer devices to be connected to the subpedal 1.

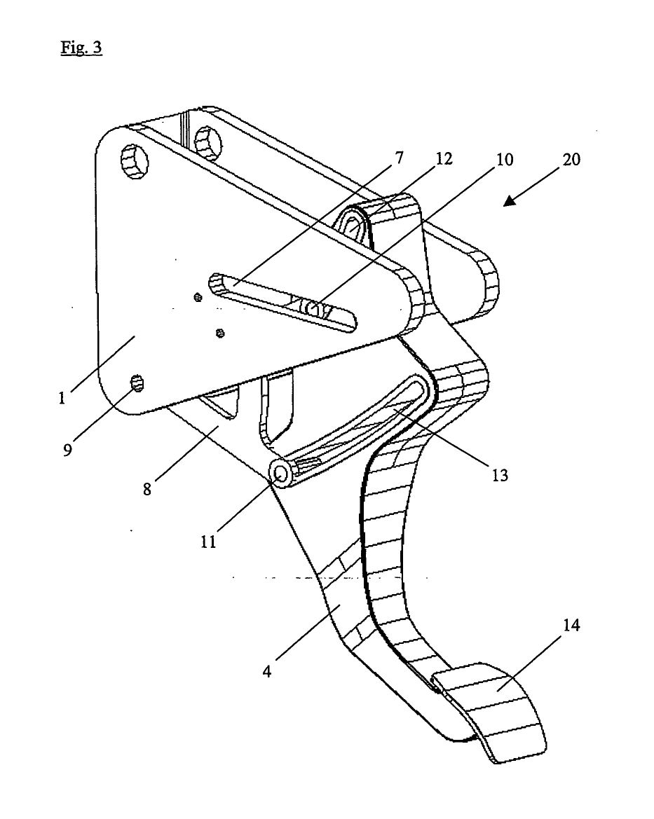

Subpedal 1 preferably consists of a symmetric U-shaped arrangement, which can best seen in FIG. 3. FIG. 1 only shows the rear leg of the U. The shape of the front leg of the U corresponds to the rear leg. Both legs have preferably a substantially flat cross-section. The two legs are interconnected at the basis of the U, positioned in FIG. 1 on the left side of the subpedal. Other embodiments of the subpedal 1, e.g. an embodiment of a single flat element, are also possible. An elongated guide 7 is provided in both legs of the U-shaped subpedal 1, preferably running substantially horizontal. Its path is preferably straight.

Sheet metal is preferably used as the material for the subpedal 1 and the positioning element 8 or the pedal 4. It is also possible to produce the elements of the pedal assembly 20 of thermoplastic or duroplastic plastic materials, in particular glass-fiber reinforced plastics.

The positioning element 8 mainly consists of one substantially flat component. In the embodiment of the FIGS. 1-4, the positioning element 8 comprises a V-shaped plate, however in other embodiments it may have any desired shape. The positioning element 8 is pivotably mounted at the vertex of the V-shaped plate at the subpedal 1 by an axis which represents the rotation point of the positioning element 9. This axis extends though both legs of the subpedal 1.

In another preferred embodiment, the positioning element 8 may consist of two flat elements having the same shape as the positioning element 8 described above. The two elements are each pivotably interconnected with the subpedal 1 at a rotation point of the positioning element 9. The interconnection is again preferably effected by means of an axis, interconnecting the two parts of the positioning element 8 in that they jointly pivot around the rotation point of the positioning element 9.

A second and a third pin 10, 11 are mounted on the respective legs of the V-shaped plate of the positioning element 8 in an axis parallel to the vehicle's transverse axis, engaging the second and third elongated guides 12, 13 of the pedal 4, as shown in FIGS. 1 and 2. Thereby, two slide links between the positioning element 8 and the pedal 4 are provided.

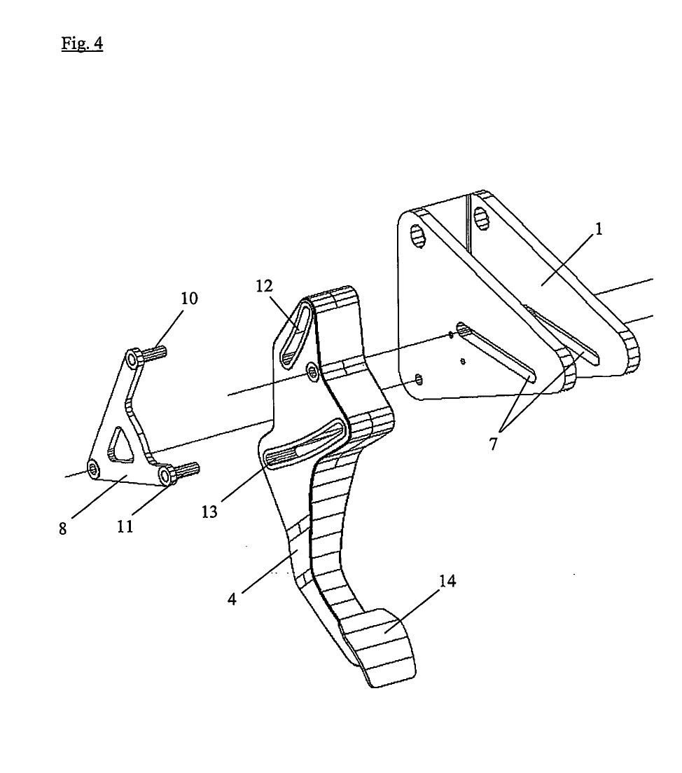

The pedal 4 substantially consists of three areas, the foot piece 14, offering good support for the actuating foot, a pedal foot, extending upwardly from the foot piece 14, and a top area, wherein the pedal 4 is connected to the subpedal 1 and the positioning element 8. This top area may be formed like shown in FIGS. 3 and 4 as a massive plate. However, in another embodiment, if is made of sheet metal it may transitioning like a fork into two parallel and substantially flat areas.

The pedal 4 is slideably connected to the subpedal 1 by means of a first pin 6 which extends through the first elongated guide 7 of the subpedal 1. By this link, the pedal 4 can slide with respect to the subpedal 1 along the path of the elongated guide 7. In this embodiment the first elongated guide 7 is substantially horizontal and straight, however it can be arbitrarily be shaped. Pin 6 can also be an independent pin which extends through the pedal 4 and the two legs of the subpedal 1.

The pedal 4 and the positioning element 8 are arranged within the two legs of the subpedal 1. In other embodiments (not shown) a different order of the elements 1, 4, 8 from the interior towards the exterior is, of course, possible. For example, the subpedal 1 can be enclosed between two upper areas of the pedal 4. The outermost part would then be the positioning element 8.

In the upper area of the pedal 4, a second elongated guide 12 and a third elongated guide 13 are provided. The elongated guides 12 and 13 are preferably slightly curved upwardly. As obvious from FIGS. 1 and 2, the position of the second elongated guide 12 is steeper than that of the third elongated guide 13.

In the shown embodiment the elongated guides 7, 12, 13 are provided as elongated holes. However, they can be provided in other forms and embodiments like elongated slots or elongated ribs, too. It is only important, that the respective parts glide or slide with respect to each other in defined directions.

During the adjustment of the pedal assembly to the various sizes of the drivers the positioning element 8 pivots around its rotation point 9. As shown in FIG. 1, the position element 8 can be pivoted along the direction of the arrow 5 to the position shown in FIG. 2. The movement, pivoting back, is also indicated in FIG. 2 by means of the arrow 5.

If the pedal is to be adjusted from its position for small drivers, as shown in FIG. 1, to the position for big drivers, as shown in FIG. 2, the position element is pivoted counter-clockwise as shown in FIG. 1. In this process, the second pin 10 of the position element is moved from bottom to top within the second elongated guide 12 of the pedal 4. The third pin 11 of the positioning element 8 moves within the third elongated guide 13 of the pedal 4 from bottom left to top right. Simultaneously, the first pin 6 of the pedal 4 moves from right to left within the first elongated guide 7 of the subpedal. These three movements of the pins 6, 10, and 11 within the corresponding elongated guides 7, 12, and 13 lead to a movement of the pedal 4 from the position shown in FIG. 1 into the position shown in FIG. 2.

The movement of the pedal 4 in relation to the subpedal 1 is defined by the orientation of the elongated guides. In the shown embodiment, the path of the first elongated guide 7 runs substantially straight and between the rotation point of the subpedal 3 and the rotation point of the positioning element 9. The rotation point of the positioning element 9 is located below the rotation point of the subpedal 3. By means of such configuration of the pedal assembly, it is possible for the pedal 4 to be displaced by a pivoting movement of the positioning element 8 substantially in parallel to the vehicle's longitudinal axis. However, during adjustment any other desired position and orientation of the pedal 4 in relation to the subpedal 1 can be achieved by an appropriate orientation of the elongated guides 7, 12 and 13. Thereby, the foot-piece 14 moves along a desired trajectory.

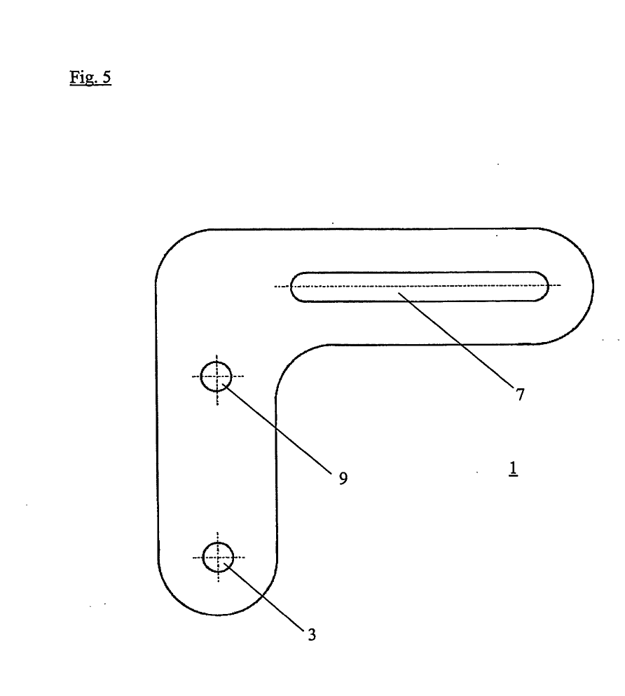

In FIG. 5 another embodiment of the subpedal 1 is shown. In this embodiment, the rotation point of the positioning element 9 is located above the rotation point of the subpedal. Such a subpedal 1 can be mounted at a fixed support 2 which is mounted in a “standing” fashion (not shown) at the vehicle body and not in “hanging” fashion as shown in FIGS. 1-3. Thereby, the rotation point of the positioning element 9 has a lower position in the vehicle compared to the above described embodiment. Preferably, the path of the first elongated guide 7 runs above the rotation point of the subpedal. In this embodiment the pedal 4 and the positioning element 8 can basically remain unchanged as shown and described with respect to the embodiment of FIGS. 1-4. The embodiment of FIG. 5 is particularly preferable for the use as a gas pedal.

As shown in FIGS. 1 and 2, the positioning element 8 only has to be pivoted in relation to the subpedal 1 by a maximum angle of 45° in order to achieve the maximum adjustment possibility of the pedal 4. Of course, the angle can be larger or smaller than 45° depending on the design of the adjustable pedal.

In FIG. 1, the pedal arrangement is shown, wherein the pedal 4 is positioned closest to the driver. FIG. 2 shows the pedal arrangement, positioning the pedal 4 farthest away from the driver. Of course, arbitrary intermediate positions can be set. The described pedal assembly 20 can set these intermediate positions continuously.

The adjustment of the adjustable pedal is effected by means of an appropriate actuator (not shown). Preferably, this actuator acts on the positioning element 8 or on the pedal 4. The actuator is preferably driven by an electric motor. However, it is also possible to drive the actuator manually.

A manual drive or an electric motor can be coupled to the positioning element 8 or the pedal 4 via common gear assemblies. It is possible to use a toothed gearing, a spindle gearing, a cam gearing, a chain drive, a belt drive, or a V-belt drive, a flexible shaft, or by a combination of said gearings.

During the use of the pedal assembly in a vehicle a force is applied on the foot-piece 14 of the pedal 4. In other words, the driver pushes the pedal with his foot at the foot-piece 14. This force is indicated by the arrow at the foot piece 14 in the FIGS. 1 and 2. Due the shown arrangement of the elongated guides 7, 12, 13 and the respective pins 6, 10, 11 the inner elements 1, 8 and 4 of the pedal assembly lock with respect to each other, if a force is actuated on the foot-piece 14. In other words, the subpedal 1, the positioning element 8 and the pedal 4 behave like one single rigid element and rotate around the rotation point of the subpedal 3.

During use of the pedal assembly the actuator must not provide any force for keeping the adjusted positions of the subpedal 1, the positioning element 8 and the pedal 4 to each other. Therefore it can be dimensioned to only provide the actuation forces and not to withstand the forces during use.

Therefore, also the security of the system is increased. The pedal assembly can still be used when the actuator may fail.

The above described pedal assemblies 20 can be grouped into a pedal assembly of a plurality of pedals. Thereby, the positioning elements 8 or the pedals 4 of the pedal assemblies can be jointly driven for a joint adjustment. Preferably, a common actuator is used for the adjustment.

### LIST OF REFERENCE NUMBERS

1 subpedal
2 fixed support
3 rotation point of the subpedal
4 pedal
5 rotating direction of the positioning element
6 first pin
7 first elongated guide
8 positioning element
9 rotation point of the positioning element
10 second pin
11 third pin
12 second elongated guide
13 third elongated guide
14 foot piece
20 pedal assembly

1-23. (canceled)

24. An adjustable pedal assembly for a motor vehicle, comprising:
a subpedal pivotably mounted to the motor vehicle;
a pedal slideably coupled to the subpedal by a first slide link; and
at least one positioning element pivotably mounted to the subpedal and slideably mounted at the pedal by a second slide link, so that the pedal glides relative to the subpedal during a pivoting of the positioning element effected by means of an actuator acting on the positioning element or the pedal, wherein the positioning element is further mounted to the pedal by a third slide link separate from the second slide link.

25. The adjustable pedal assembly of claim 24, wherein the positioning element consists only of a single element mounted to the pedal by the second and third slide links.

26. The adjustable pedal assembly of claim 24, wherein the subpedal comprises a first elongated guide and wherein the pedal is slideably supported within this first elongated guide by a link, so that the pedal is adjustable substantially in parallel to a longitudinal axis of the motor vehicle.

27. The adjustable pedal assembly of claim 26, wherein the pedal comprises second and third elongated guides.

28. The adjustable pedal assembly of claim 27, wherein first, second, and third paths defined respectively by the first, second, and third elongated guides are arranged such that when a force is applied to a foot-piece of the pedal, a locking in relative movement of the subpedal, the pedal and the positioning element to each other is produced.

29. The adjustable pedal assembly of claim 28, wherein the first, second, and third paths are arranged such that a foot-piece of the pedal follows a predetermined trajectory during adjustment of the pedal.

30. The adjustable pedal assembly of claim 27, wherein the pedal comprises a first pin engaging the first elongated guide, wherein the positioning element comprises a second pin engaging the second elongated guide, and wherein the positioning element comprises a third pin engaging the third elongated guide, wherein the first, second and third pins and the first, second, and third elongated guides constitute the first, second and third slide links.

31. The adjustable pedal assembly of claim 28, wherein the first second and third paths are substantially parallel to a plane defined by a longitudinal axis and a vertical axis of the motor vehicle.

32. The adjustable pedal assembly of claim 26, wherein a path defined by the first elongated guide is substantially straight.

33. The adjustable pedal assembly of claim 27, wherein second and third paths defined respectively by the second and the third elongated guide are curved.

34. The adjustable pedal assembly of claim 26, wherein a path defined by the first elongated guide is arranged substantially horizontal when the pedal is not actuated.

35. The adjustable pedal assembly of claims 24, wherein the positioning element is pivotable around an axis which is substantially parallel to a transverse axis of the motor vehicle.

36. The adjustable pedal assembly of claim 24, wherein a rotation point of the positioning element is located below a rotation point of the subpedal.

37. The adjustable pedal assembly of claim 36, wherein the subpedal comprises a first elongated guide, and wherein a path defined by the first elongated guide is directed between the rotation point of the subpedal and the rotation point of the positioning element.

38. The adjustable pedal assembly of claim 24, wherein a rotation point of the positioning element is located above a rotation point of the subpedal.

39. The adjustable pedal assembly of claim 38, wherein the subpedal comprises a first elongated guide, and wherein a path defined by the first elongated guide lies above the rotation point of the subpedal.

40. The adjustable pedal assembly of claim 30, wherein the sub-pedal comprises two external parallel walls which are mechanically connected, wherein the at least one positioning element and the pedal are mounted in-between the two walls by means of the first, second, and third elongated guides and the first, second, and third pins.

41. The adjustable pedal assembly of claim 30, wherein the at least one positioning element comprises a V-shaped plate pivotably mounted at a vertex of the V-shaped plate and wherein the second and third pins are arranged at the arms of the V-shaped plate.

42. The adjustable pedal assembly of claim 24, wherein an actuator acting on the positioning element or the pedal is driven by an electric motor.

43. The adjustable pedal assembly of claim 24, wherein an actuator acting on the positioning element or the pedal is manually driven.

44. The adjustable pedal assembly of claim 43, wherein the actuator is driven by at least one gearing selected from a group of gearings comprising a toothed wheel gearing, a spindle gearing, a cam gearing, a chain drive, a belt drive, a V-belt drive, and a flexible shaft.

45. The adjustable pedal assembly of claim 24, further comprising at least a second pedal assembly so that the pedal assembly and the second pedal assembly form a pedal unit, wherein the positioning elements or the pedals of each pedal assembly are jointly driven for a joint adjustment.

46. The adjustable pedal assembly of claim 45, wherein only a single common adjustment means is used for adjustment.
